(19) United States
(12) Patent Application Publication
(10) Pub. No.: US 2026/0142309 A1
(43) Pub. Date: May 21, 2026

(54) Spring contacts in a sub-housing for a rechargeable battery

(71) Applicant: Hilti Aktiengesellschaft, Schaan (LI)

(72) Inventors: Florian MAYR, Kaufbeuren (DE); Markus HARTMANN, Mauerstetten (DE); Uwe HAINKE, Dresden (DE)

(21) Appl. No.: 18/706,062

(22) PCT Filed: Nov. 15, 2022
(86) PCT No.: PCT/EP2022/081902

§ 371 Date: Apr. 30, 2024

(30) Foreign Application Priority Data
Dec. 1, 2021 (EP) 21211593.5

(51) Int. Cl. H01M 50/296; H01M 50/247

(52) U.S. Cl. CPC H01M 50/296; H01M 50/247; H01M 2220/30

(57) ABSTRACT

A rechargeable battery, preferably as a removable energy supply for a power tool, including at least one energy storage cell and a connection apparatus for removably connecting the rechargeable battery to a power tool, the connection apparatus including at least a first, second and third connection element. The connection apparatus includes a holding and receiving apparatus for at least partially receiving the first, second and third connection element, each connection element being connected to the holding and receiving apparatus via at least one compensating element in such a way that a relative movement between the connection element and the holding and receiving apparatus in at least one direction can be compensated.

The present invention relates to a rechargeable battery, preferably as a removable energy supply for a power tool, comprising at least one energy storage cell and a connection apparatus for removably connecting the rechargeable battery to a power tool, the connection apparatus comprising at least a first, second and third connection element.

### BACKGROUND

So-called cordless power tools, for example cordless screwdrivers, drills, saws and grinding machines, or the like, may be connected to one or more rechargeable batteries for power-supply purposes. In this case, the rechargeable battery has a plurality of energy storage cells, also known as accumulator cells, by means of which electrical energy may be received, stored and output again. If the rechargeable battery is connected to a power tool, the electrical energy stored in the energy storage cells may be fed to the consumer (e.g. a brushless electric motor) of the power tool. For charging purposes, i.e. for charging the energy storage cells with electrical energy, the rechargeable battery is connected to a charging apparatus so that electrical energy may reach the energy storage cells.

### SUMMARY OF THE INVENTION

When using or working with a battery-operated power tool, significant vibrations and shocks may occur in the power tool and in the rechargeable battery connected to the power tool. This is especially the case if the power tool is a demolition tool, e.g. a chipping or demolition hammer. The vibrations and shocks during the use of the power tool place a certain amount of strain on virtually all components and assemblies of the power tool and of the rechargeable battery. This strain may ultimately result in damage to the respective components or even to a total failure of the power tool as a whole.

However, the interface between the power tool and the rechargeable battery poses a particular problem. At the interface, the electrical contacts of the power tool and the electrical contacts of the rechargeable battery are connected to one another such that the electrical energy stored in the energy storage cells may make its way from the rechargeable battery to the power tool. As a result of the rechargeable battery merely being in removable contact with the power tool via the interface, the respective electrical contacts of the power tool and of the rechargeable battery abut against one another with force fit. In this case, such force-fitting connections usually consist of a spring-mounted clip (i.e. female contact) and an insertion element (i.e. male contact), which can be inserted into the clip.

The vibrations and shocks in the power tool and in the rechargeable battery connected to the power tool may result in a relative movement and even in an actual break in the contact. The relative movement should be prevented since it may lead to wear or premature deterioration of the contacts. A break in the contact may result in undesired sparking or even an arc at the contacts.

A vibration- and shock-proof connection of the respective electrical contacts.

An object of the present invention, therefore, is to provide a battery interface for a rechargeable battery, preferably as a removable energy supply for a power tool, having a connection apparatus, which has at least a first, second and third connection element, by means of which the above-mentioned problem may be solved and a vibration- and shock-proof connection may be achieved.

The present invention provides a rechargeable battery, preferably as a removable energy supply for a power tool, comprising at least one energy storage cell and a connection apparatus for removably connecting the rechargeable battery to a power tool, the connection apparatus comprising at least a first, second and third connection element.

According to the invention, provision is made for the connection apparatus to comprise a holding and receiving apparatus for at least partially receiving the first, second and third connection element, each connection element being connected to the holding and receiving apparatus via at least one compensating element in such a way that a relative movement between the connection element and the holding and receiving apparatus in at least one direction can be compensated.

It is thus possible to easily compensate vibrations and shocks which act on the connection elements and may result in a relative movement and even an actual break in the contact between the rechargeable battery and the power tool.

According to an advantageous embodiment of the present invention, provision may therefore be made for the holding and receiving apparatus to comprise at least a first, second and third substantially elongated chamber, in which a connection element having an associated compensating element can be positioned in each case so that the connection element can be reversibly moved in a direction relative to the respective chamber by means of the associated compensating element.

In this case, a chamber may receive more than one connection element. In this regard, for example, a first chamber may comprise two, or more than two, connection elements which are configured as positive poles. Accordingly, a second chamber may also comprise two, or more than two, connection elements which are configured as negative poles and a third chamber may comprise two, or more than two, connection elements which are configured as communication elements. According to alternative embodiments, it may be possible for each chamber to be configured in the form of a frame, without continuous or closed side walls.

In this case, the compensating element may be configured in the form of a spring, and in particular a spiral spring. Alternatively, the compensating element may be configured as a component of an elastically deformable material. An elastomer is also a possible material in this case. It is thus possible to easily counteract a vibration-related movement of the connection element in multiple directions, i.e. not only in the direction towards or away from the connection element.

According to a further advantageous embodiment of the present invention, provision may be made for at least two chambers to be arranged on the holding and receiving apparatus such that they are offset from one another in at least one plane. It is thus possible to reduce a mechanical resistance, which may arise if too many connection elements lying in one plane are to be brought into contact with corresponding contact elements of a power tool or a charging device at the same time. As a result of the offset arrangement, a first number of connection elements of the rechargeable battery may firstly be brought into contact with corresponding connecting elements of a power tool or a charging device and then a second number of connection elements of the rechargeable battery may subsequently be brought into contact with corresponding connecting elements of a power tool or a charging device.

According to an additional advantageous embodiment of the present invention, provision may be made for the first chamber to be connected to the second chamber via a first elastic connecting element and the second chamber to be connected to the third chamber via a second elastic connecting element. It is thus possible to easily counteract a relative movement, caused by vibrations and shocks, between the the first, second and third chamber.

According to a further advantageous embodiment of the present invention, provision may be made for the first chamber to be connected to the second chamber via a first rigid connecting element and the second chamber to be connected to the third chamber via a second rigid connecting element. It is thus possible to prevent a relative movement between the first chamber and the second chamber and a relative movement between the second chamber and the third chamber. It is furthermore thus possible to also prevent a relative movement between the first chamber and the third chamber.

According to an advantageous embodiment of the present invention, provision may therefore be made for the connecting elements of the power tool or a charging device to be configured in the form of pin-like plugs and the connection elements of the battery interface to be configured in the form of clips with elastically deformable plates for receiving pin-like plugs.

### BRIEF DESCRIPTION OF THE DRAWINGS

Further advantages will become apparent from the following description of the figures. Various exemplary embodiments of the present invention are illustrated in the figures.

The figures, the description and the claims comprise numerous features in combination. A person skilled in the art will expediently also consider the features individually and combine them to produce useful further combinations.

In the drawing:

FIG. 1 shows a side view of a power tool according to the invention comprising a rechargeable battery which is connected to the power tool;

FIG. 2 shows a further side view of the power tool according to the invention comprising a rechargeable battery which is disconnected from the power tool;

FIG. 3 shows a perspective detail view of an interface apparatus of the power tool;

FIG. 4 shows a side view of the rechargeable battery with a connection apparatus;

FIG. 5 shows a plan view of the connection apparatus of the rechargeable battery according to the first embodiment;

FIG. 6 shows a perspective view of the connection apparatus of the rechargeable battery according to the first embodiment; and

FIG. 7 shows a perspective view of the connection apparatus of the rechargeable battery according to a second embodiment.

### DETAILED DESCRIPTION

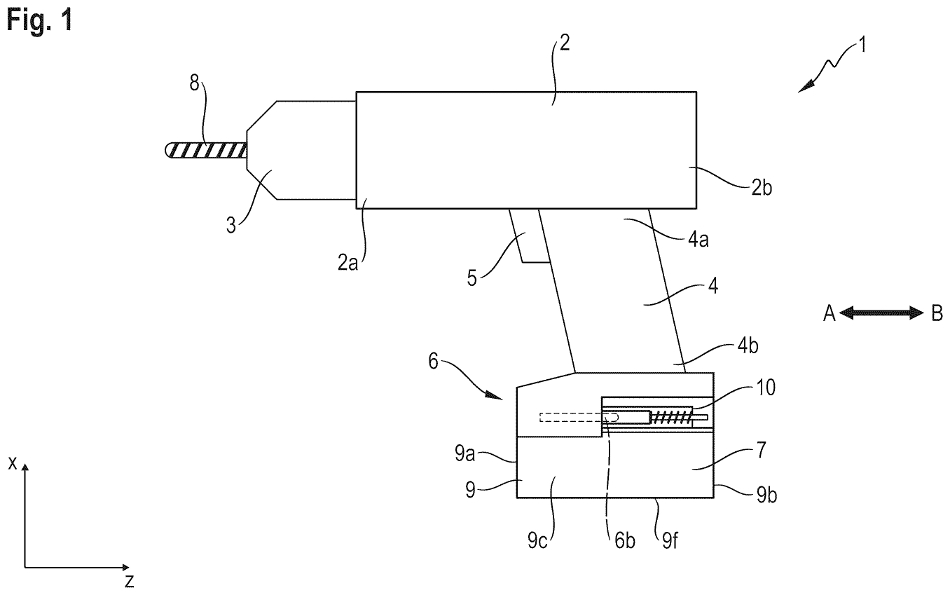

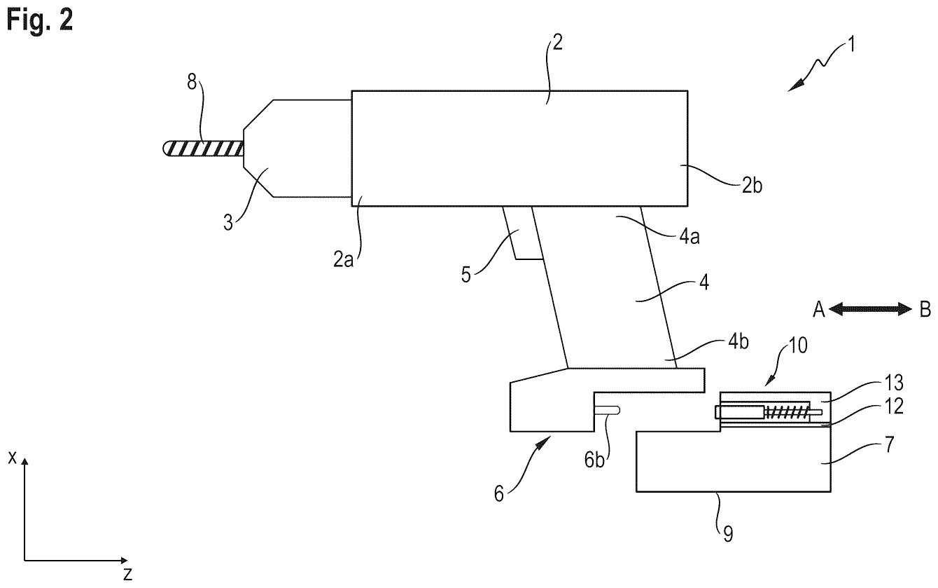

An exemplary embodiment of a power tool 1 is illustrated in FIGS. 1 and 2.

The power tool 1 in this case is configured in the form of a drill. However, it is also possible that the power tool 1 is a hammer drill, a circular saw, a grinding machine or the like.

The power tool 1 illustrated in FIGS. 1 and 2 substantially comprises a housing 2, a tool fitting 3, a handle 4 with an activation switch 5. The power tool 1 furthermore comprises an interface apparatus 6 for a rechargeable battery 7.

In FIG. 1, a state is shown in which the rechargeable battery 7 is connected to the power tool 1. To this end, the rechargeable battery 7 is pushed onto the interface apparatus 6 in arrow direction A. As shown in FIG. 2, the rechargeable battery 7 may be removed from the interface apparatus 6 again, and therefore from the power tool 1, according to arrow direction B. If the rechargeable battery 7 is connected to the power tool 1, electrical energy may make its way from the rechargeable battery 7 to the power tool 1.

The housing 2 of the power tool 1 has a first end 2a and a second end 2b. The tool fitting 3 is positioned at a first end 2a of the housing 2. The tool fitting 3 serves for receiving and removably holding a tool 8. The tool 8 shown in FIGS. 1 and 2 is configured in the form of a drill.

An electric motor for generating a torque is positioned in the interior of the housing 2. The electric motor is therefore an electric consumer of electrical energy. The torque generated in the electric motor is transmitted to the tool fitting 3 via an output shaft and a gear system. The tool 8 is rotated by means of the transmitted torque.

The handle 4 comprises the activation switch 5, a first end 4a and a second end 4b. The activation switch 5 serves for the actuation or activation of the power tool 1 by a user.

The first end 4a of the handle 4 is secured at a second end 2b of, and underneath, the housing 2.

The interface apparatus 6 for removable connection of the rechargeable battery 7 is positioned at the second end 4b of the handle 4. According to a first embodiment, the interface apparatus 6 comprises a first, second and third connecting element 6a, 6b, 6c.

Alternatively and according to further embodiments, the interface apparatus 6 may also comprise more or fewer than a first, second and third connecting element.

According to the first embodiment, the first connecting element 6a is configured as a positive pole, the second connecting element 6b is configured as a negative pole and the third connecting element 6c is configured as a communication element. By configuring the first connecting element 6a as a positive pole and the second connecting element 6b as a negative pole, an electric circuit between the power tool 1 and the rechargeable battery 7 may be created or closed for the purpose of supplying electrical energy to the power tool 1. By means of the third connecting element 6c, which is configured as a communication element, information in the form of data and signals may be received and sent by the power tool 1 so that communication may take place between the power tool 1 and the rechargeable battery 7.

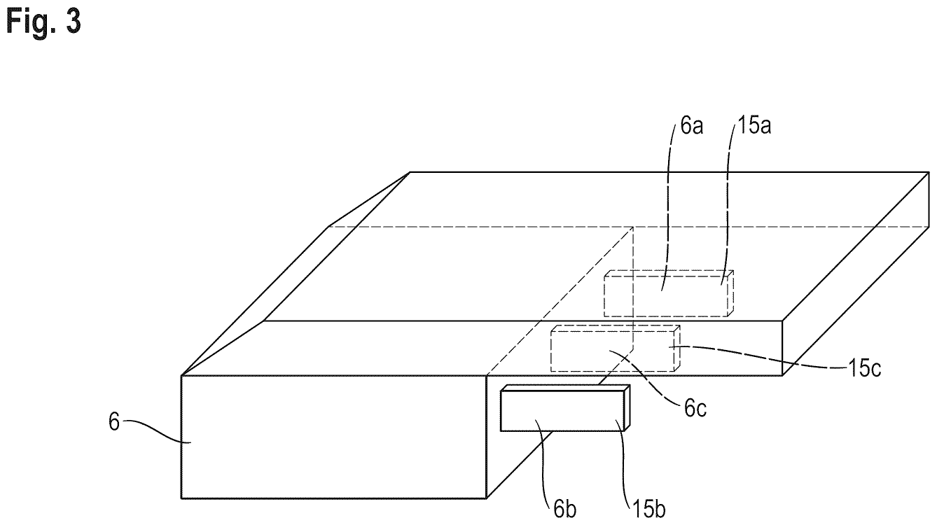

In this case, as shown in FIG. 3, the third connecting element 6c, which is configured as a communication element, is arranged on the interface apparatus 6 between the first connecting element 6a, which is configured as a positive pole, and the second connecting element, 6b, which is configured as a negative pole, and therefore substantially in the center of the interface apparatus 6. Alternatively, however, other arrangements of the three or more connecting elements are also possible.

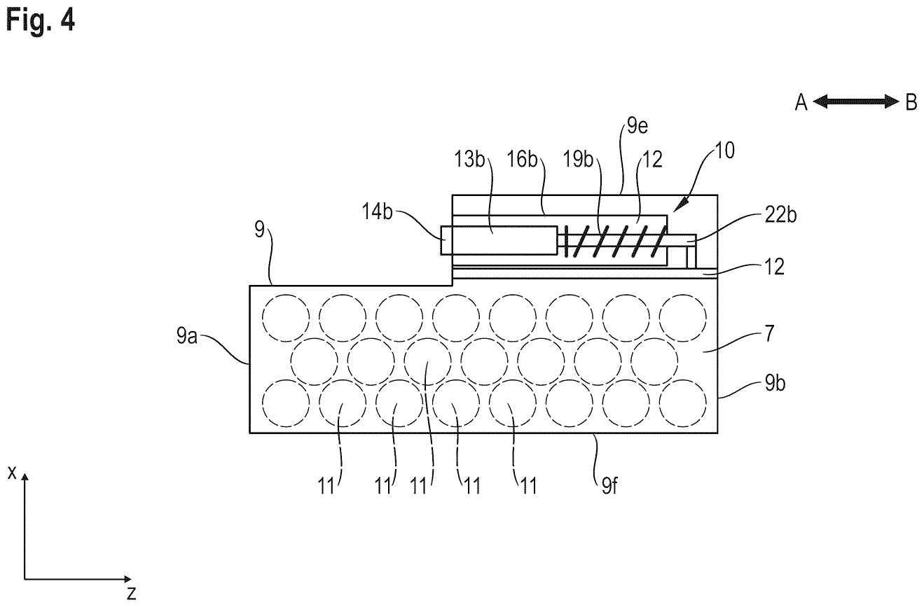

As shown in particular in FIG. 4, the rechargeable battery 7 substantially comprises a battery housing 9. In this case, the battery housing 9 in turn comprises a front side 9a, a rear side 9b, a left-hand side wall 9c, a right-hand side wall, a top side 9e and an underside 9f. Only the left-hand side wall 9c of the battery housing 9 is shown in FIGS. 1 and 2; however, the left-hand and right-hand side wall are substantially identical.

A connection apparatus 10 is positioned on the top side 9e of the battery housing 9. The connection apparatus 10 may also be referred to as a battery interface apparatus.

A number of individual, mutually connected energy storage cells 11, also known as battery cells, are positioned in the interior of the battery housing 9. Moreover, the respective energy storage cells 11 are connected to the connection apparatus 10. By means of the energy storage cells 11, electrical energy may be received and stored in the rechargeable battery 7, and output again. The connection of the battery cells 11 to one another and the connection of the battery cells 11 to the connection apparatus 10 are not illustrated in the figures.

Furthermore, the rechargeable battery 7 comprises a control apparatus 12 by means of which the functions of the rechargeable battery 7 are controlled and regulated. The functions of the rechargeable battery 7 which may be controlled and regulated by the control apparatus 12 include, for example, regulating the quantity of electrical energy or blocking the output of electrical energy from the energy storage cells 11. The control apparatus 12 of the rechargeable battery 7 is connected to the energy storage cells 11. The connections of the control apparatus 12 to the individual energy storage cells 11 are not indicated in the figures.

In this case, the connection apparatus 10 substantially comprises a holding and receiving apparatus 13 for receiving and holding a first, second and third connection element 13a, 13b, 13c. The first, second and third connection element 13a, 13b, 13c is connected to the control apparatus 12 in each case.

According to the first embodiment, the first connection element 13a is configured as a positive pole, the second connection element 13b is configured as a negative pole and the third connection element 13c is configured as a communication element. According to alternative embodiments, more than three connection elements may be provided so that, for example, a first and second positive pole, a first and second negative pole and a first and second communication element are comprised in the holding and receiving apparatus 13.

As indicated in FIGS. 1 and 2, the first connection element 13a of the rechargeable battery 7, which is configured as a positive pole, serves for removable connection to the corresponding first connecting element 6a of the power tool 1, which is configured as a positive pole. The second connection element 13b of the rechargeable battery 7, which is configured as a negative pole, in turn serves for removable connection to the corresponding connecting element 6b of the power tool 1, which is configured as a negative pole. Furthermore, the third connection element 13c of the rechargeable battery 7, which is configured as a communication element, serves for removable connection to the corresponding third connecting element 6c of the power tool 1, which is configured as a communication element.

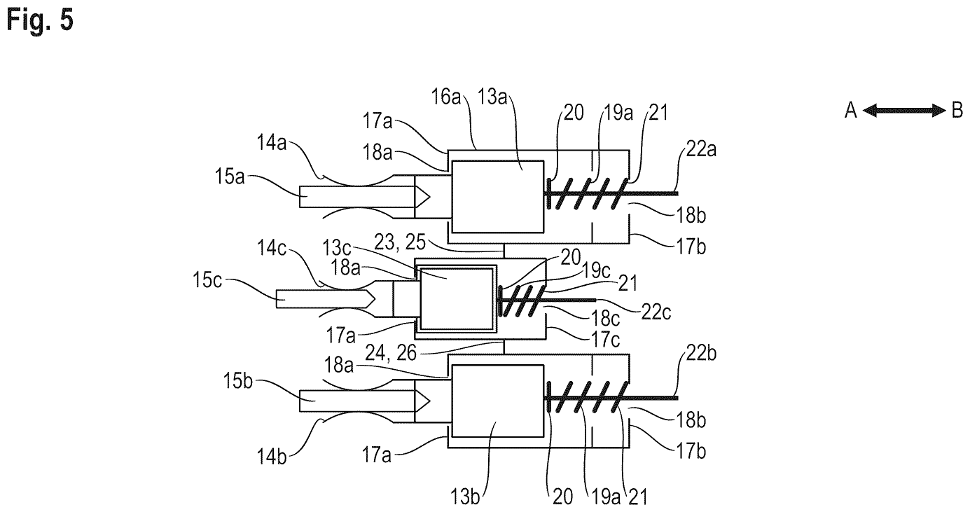

In this case, as shown in particular in FIG. 5, the first, second and third connection element 13a, 13b, 13c of the rechargeable battery 7 each comprise a terminal 14a, 14b, 13c. The terminal may also be referred to as a clip.

The first, second and third connecting element 6a, 6b, 6c of the power tool 1, on the other hand, each comprise a blade 15a, 15b, 15c as a contact. The blade 15a, 15b, 15c may also be configured as an elongated contact pin so that each connecting element 6a, 6b, 6c of the power tool 1 may be received in the corresponding connection element 13a, 13b, 13c of the rechargeable battery 7. A certain spring force of the connection elements 13a, 13b, 13c holds the connecting element 6a, 6b, 6c securely and brings it into a contacting state.

As can likewise be seen in FIG. 5, the connection apparatus 13 comprises a first, second and third chamber 16a, 16b, 16c. Each chamber 16a, 16b, 16c serves for receiving at least one connection element 13a, 13b, 13c. The chamber 16a, 16b, 16c may also be referred to as a duct.

According to alternative embodiments, it may be possible for each chamber to be configured in the form of a frame, without continuous or closed side walls.

In this case, each chamber 16a, 16b, 16c has a first end 17a and a second end 17b. A first opening 18a is provided at the first end 17a of each chamber 16a, 16b, 16c and a second opening 18b is provided at the second end 17b of each chamber 16a, 16b, 16c.

The opening may also be referred to as a cutout.

The first connection element 13a is positioned in the first chamber 16a, the second connection element 13b is positioned in the second chamber 16b and the third connection element 13c is positioned in the third chamber 16c.

As already mentioned above, according to an alternative embodiment, it may be possible that a chamber receives more than one connection element. In this regard, for example, a first chamber 16a may comprise two, or more than two, connection elements which are configured as positive poles. Accordingly, a second chamber 16b may also comprise two, or more than two, connection elements which are configured as negative poles and a third chamber 16c may comprise two, or more than two, connection elements which are configured as communication elements.

As already indicated above, each chamber 16a, 16b, 16c is configured to be substantially elongated and, in this case, is dimensioned to be somewhat longer than the corresponding connection element 13a, 13b, 13c positioned in the respective chamber 16a, 16b, 16c. The chamber 16a, 16b, 16c is configured to be longer so that the connection element 13a, 13b, 13c may move in the chamber 16a, 16b, 16c in arrow direction A or B. The respective terminal 14a, 14b, 14c of a connection element 13a, 13b, 13c projects out of the respective chamber 16a, 16b, 16c through the first opening 18a at the first end 17a of each chamber 16a, 16b, 16c such that the two limbs of each terminal 14a, 14, 14c are freely movable outside the chamber 16a, 16b, 16c for the purpose of receiving a blade 15a, 15b, 15c of a connecting element 16a, 6b, 6c of the power tool, c.f. FIG. 5.

Each connection element 13a, 13b, 13c furthermore comprises a compensating element 19a, 19b, 19c in each case. In the present exemplary embodiment, each compensating element 19a, 19b, 19c is configured in the form of a spiral spring and, in particular, as a compression spring. In this case, each spring has a first and second end 20, 21. As shown in particular in FIG. 5, the first end 20 of a compensating element 19a, 19b, 19c, which is configured as a spring, is connected to the respective rear end of a connection element 13a, 13b, 13c. The second end 21 of a compensating element 19a, 19b, 19c, which is configured as a spring, is connected to the respective second end 17b of a chamber 16a, 16b, 16c. As a result of the special configuration of the compensating element 19a, 19b, 19c as a compression spring, and as a result of its positioning between the second end 17b of a chamber 16a, 16b, 16c and the rear end of the connection element 13a, 13b, 13c, the connection element 13a, 13b, 13c is pressed in arrow direction A. Moreover, the connection element 13a, 13b, 13c may be moved in arrow direction B in opposition to the spring force of the compensating element. A movement of the connection element 13a, 13b, 13c in arrow direction A or B within the chamber 16a, 16b, 16c may occur due to vibration or shocks.

The first, second and third connection element 13a, 13b, 13c comprises a connecting line 22a, 22b, 22c in each case. The connecting line 22a, 22b, 22c serves for connecting the connection elements 13a, 13b, 13c to the control apparatus 12 of the rechargeable battery 7. In the case of the first and second connection element 13a, 13b, the respective connecting line 22a, 22b is configured to conduct an electric current.

The connecting line 22a, 22b of the first and second connection element 13a, 13b may also be referred to as a stranded wire.

In the case of the third connection element 13c, the connecting line 22c is configured to conduct data and information in the form of electrical signals.

As indicated in the figures, the respective connecting line extends through the compensating element which is configured as a compression spring.

By means of the compensating element 19a, 19b, 19c, which is configured as a compression spring, the connection elements 13a, 13b, 13c are pressed in direction A, or in the direction of the connecting elements 6a, 6b, 6c, in a connected state, i.e. when the connection elements 13a, 13b, 13c of the rechargeable battery 7 and the connecting elements 6a, 6b, 6c of the power tool 1 are in contact.

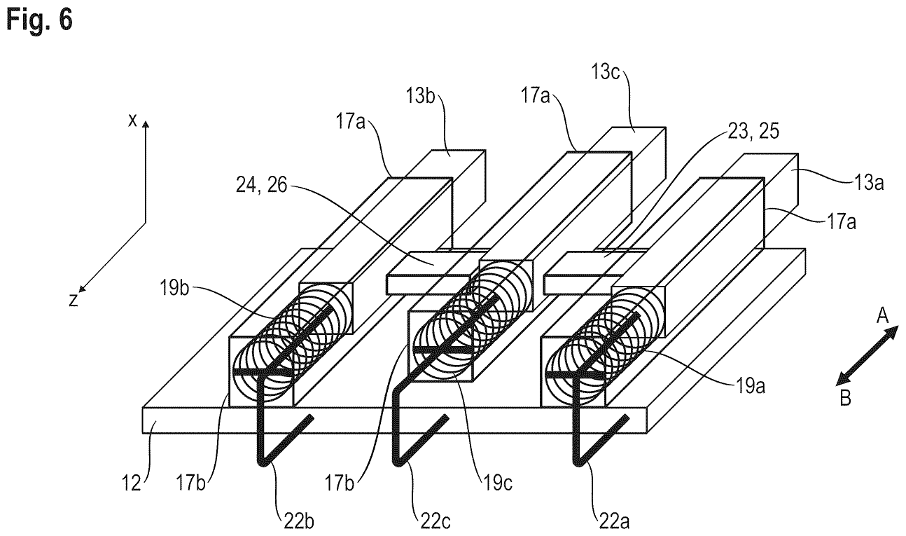

FIG. 6 shows the holding and receiving apparatus 13 according to the first embodiment. The first, second and third chamber 16a, 16b, 16c and the first, second and third connection element 13a, 13b, 13c are positioned in one plane. The third connection element 13c and the third chamber 16c, however, are arranged offset from the first and second connection element 13a, 13b and from the first and second chamber 16a, 16b in arrow direction A.

As a result of the special mutually offset arrangement of the connection elements 13a, 13b, 13c, the third connection element 13c is firstly connected to the corresponding connecting element 6c of the power tool 1. The first and second connection elements 13a, 13b are subsequently connected to the corresponding first and second connecting element 6a, 6b of the power tool 1. The mechanical resistance when connecting the rechargeable battery 7 to the power tool 1 is lower due to the fact that all three connection elements 13a, 13b, 13c are not connected to the corresponding connecting element 6a, 6b, 6c at the same time.

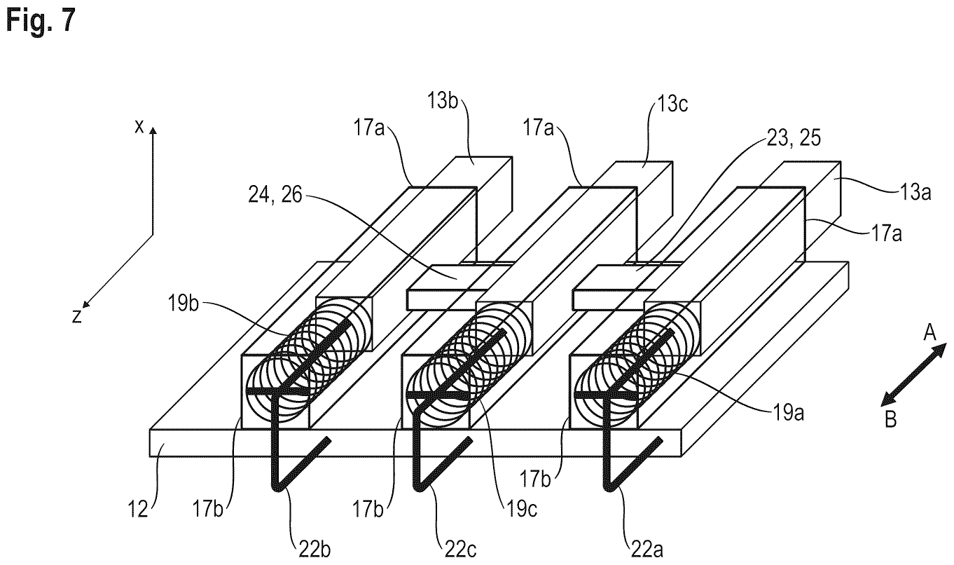

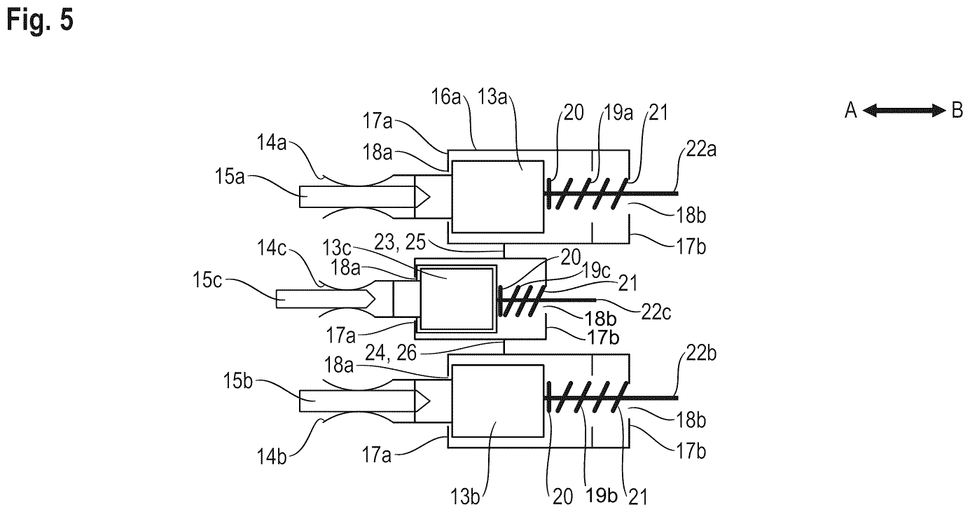

FIG. 7 shows the holding and receiving apparatus 13 according to a second embodiment. As in the first embodiment, the first, second and third chamber 16a, 16b, 16c and the first, second and third connection element 13a, 13b, 13c are likewise positioned in one plane. Moreover, the first, second and third chamber 16a, 16b, 16c and the first, second and third connection element 13a, 13b, 13c are not offset and are arranged substantially in a line.

According to an alternative embodiment, the first chamber 18a is connected to the second chamber 18b via a first elastic connecting element 23 and the second chamber is connected to the third chamber 18c via a second elastic connecting element 24, c.f. FIGS. 6 and 7.

According to a further alternative embodiment, the first chamber 18a is connected to the second chamber 18b via a first rigid connecting element 25 and the second chamber 18b is connected to the third chamber 18c via a second rigid connecting element 26, c.f. FIGS. 6 and 7.

LIST OF REFERENCE SIGNS

| | |
|---|---|
| 1 | Power tool |
| 2 | Housing of the power tool |
| 2a | First end of the housing of the power tool |
| 2b | Second end of the housing of the power tool |
| 3 | Tool fitting |
| 4 | Handle |
| 4a | First end of the handle |
| 4b | Second end of the handle |
| 5 | Activation switch |
| 6 | Interface apparatus |
| 6a | First connecting element of the interface apparatus |
| 6b | Second connecting element of the interface apparatus |
| 6c | Third connecting element of the interface apparatus |
| 7 | Rechargeable battery |
| 8 | Tool |
| 9 | Battery housing |
| 9a | Front side of the battery housing |
| 9b | Rear side of the battery housing |
| 9c | Left-hand side wall of the battery housing |
| 9e | Top side of the battery housing |
| 9f | Underside of the battery housing |
| 10 | Connection apparatus |
| 11 | Energy storage cell |
| 12 | Control apparatus |
| 13 | Holding and receiving apparatus |
| 13a | First connection element |
| 13b | Second connection element |
| 13c | Third connection element |
| 14a | First terminal |
| 14b | Second terminal |
| 14c | Third terminal |
| 15a | First blade |
| 15b | Second blade |
| 15c | Third blade |
| 16a | First chamber |
| 16b | Second chamber |
| 16c | Third chamber |
| 17a | First end of a chamber |
| 17b | Second end of a chamber |
| 18a | First opening of a chamber |
| 18b | Second opening of a chamber |
| 19a | First compensating element |
| 19b | Second compensating element |
| 19c | Third compensating element |
| 20 | First end of a compensating element |
| 21 | Second end of a compensating element |
| 22a | First connecting line |
| 22b | Second connecting line |
| 22c | Third connecting line |
| 23 | First elastic connecting element |
| 24 | Second elastic connecting element |
| 25 | First rigid connecting element |
| 26 | Second rigid connecting element |

1-5. (canceled)

6: A rechargeable battery comprising:
at least one energy storage cell; and
a connection apparatus for removably connecting the rechargeable battery to a power tool, the connection apparatus including first, second and third connectors, and including a holding and receiving apparatus for at least partially receiving the first, second and third connectors, each of the first, second and third connectors being connected to the holding and receiving apparatus via at least one compensator in such a way that a relative movement between the first, second and third connectors and the holding and receiving apparatus in at least one direction can be compensated.

7: The rechargeable battery as recited in claim 6 wherein the holding and receiving apparatus includes elongated first, second and third chambers, an associated compensator of the at least one compensator positionable respectively in the first, second or third chamber so that the respective first, second or third connector is reversibly movably in a direction relative to the respective first, second or third chamber via the associated compensator.

8: The rechargeable battery as recited in claim 7 wherein at least two of the first, second and third chambers are arranged on the holding and receiving apparatus to be offset from one another in at least one plane.

9: The rechargeable battery as recited in claim 7 wherein the first chamber is connected to the second chamber via a first elastic connector and the second chamber is connected to the third chamber via a second elastic connector.

10: The rechargeable battery as recited in claim 7 wherein the first chamber is connected to the second chamber via a first rigid connector and the second chamber is connected to the third chamber via a second rigid connector.

11: The rechargeable battery as recited in claim 7 wherein the battery is a removable energy supply for a power tool.
